(19) United States
(12) Patent Application Publication
(10) Pub. No.: US 2023/0154233 A1
(43) Pub. Date: May 18, 2023

(54) APPARATUS AND METHOD FOR FACE RECOGNITION USING USER TERMINAL

(71) Applicant: Deep ET, Seoul (KR)

(72) Inventor: Yong Beom CHO, Seoul (KR)

(21) Appl. No.: 17/558,042

(22) Filed: Dec. 21, 2021

(30) Foreign Application Priority Data
Nov. 16, 2021 (KR) 10-2021-0157155

(51) Int. Cl. G06V 40/16; H04W 4/80; G06V 40/50; H04N 7/18; G06T 7/11

(52) U.S. Cl. CPC G06V 40/172; H04W 4/80; G06V 40/50; H04N 7/18; G06V 40/166; G06T 7/11; G06T 2207/20021; G06T 2207/30201

(57) ABSTRACT

Provided are face recognition apparatus and method using a user terminal. The face recognition method using a user terminal includes acquiring image data including a facial region of a subject, acquiring face information which is encrypted to be stored in a user terminal of the subject, and determining whether an image of the facial region and the face information match each other.

### BACKGROUND

### Field

The present disclosure relates to an apparatus and a method for face recognition using a user terminal.

### Description of the Related Art

Face recognition is a technique which belongs to the field of big data and captures, analyzes, and compares detailed information of a face of a person to identify or confirm an identity of the person and detects and measures various facial characteristics such as positions of eyes, eyebrows, nose, mouth, jaw, and ears of a subject using biometric science.

Recently, as a countermeasure for the global spread of infectious diseases, interests and demands for face information processing technology which is capable of providing non-face-to-face identification and service are increasing. Further, rapid expansion of related industries and services is also expected, by the support of continuous algorithm improvement, development of latest artificial intelligence (AI) techniques, and fast leap of computing performance.

In the meantime, even though the accuracy of the face recognition is increasing, there is still a limitation that it is a difficult task to completely distinguish between a verified user and a non-verified user.

A related art of the present disclosure is disclosed in Korean Registered Patent Publication No. 10-2117824.

### SUMMARY

The present disclosure makes an effort to solve the above-described problems of the related art and an object thereof is to provide an apparatus and a method for face recognition using a user terminal which perform authentication for a face image of the user who wants to access a target space by utilizing encrypted face information stored in a user terminal.

However, objects to be achieved by various embodiments of the present disclosure are not limited to the technical objects as described above and other technical objects may be present.

As a technical means to achieve the above-described technical object, according to an aspect of the present disclosure, a face recognition method using a user terminal may include acquiring image data including a facial region of a subject; acquiring face information which is encrypted to be stored in a user terminal of the subject; and determining whether an image of the facial region and the face information match each other.

Further, the image data may be acquired by a control camera which is installed to be adjacent to an access door provided in a boundary region of a target space so as to selectively allow the subject to access the target space.

Further, the acquiring of face information may include allowing the face recognition apparatus to interwork with the user terminal to perform near field wireless communication with the user terminal; and allowing the face recognition apparatus to receive the face information from the user terminal through the near field wireless communication.

Further, the user terminal may participate in a blockchain network for synchronizing and managing the face information.

Further, the face information may be encrypted in a predetermined digital key format associated with the blockchain network.

Further, in the blockchain network, a surrounding terminal which is a user terminal of a surrounding person having a predetermined personal relationship with the subject and a control station server provided to manage an accessor to the target space may participate.

Further, in the acquiring of face information, the face information may be received from the control station server.

Further, in the acquiring of face information, when a distance between the face recognition apparatus and the user terminal is out of an allowable range of the near field wireless communication, the face information may be received from the control station server.

Further, according to an exemplary embodiment of the present disclosure, a face recognition method using a user terminal may include opening the access door on the basis of the matching result.

Further, according to an exemplary embodiment of the present disclosure, a face recognition method using a user terminal may include after the acquiring of image data, partitioning the facial region included in the image data; and verifying whether the image of the facial region corresponds to an actual face which is not forged or modified.

In the meantime, according to another aspect of the present disclosure, a face recognition apparatus using a user terminal may include an image collecting unit configured to acquire image data including a facial region of a subject; a face information acquiring unit configured to acquire face information which is encrypted to be stored in a user terminal of the subject; and determining whether an image of the facial region and the face information match each other.

Further, the image collecting unit may receive the image data from a control camera which is installed to be adjacent to an access door provided in a boundary region of a target space so as to selectively allow the subject to access the target space.

Further, the face information acquiring unit may interwork with the user terminal so as to allow the near field wireless communication with the user terminal and receive the face information from the user terminal through the near field wireless communication.

Further, the face information acquiring unit may receive the face information from the control station server.

The face recognition apparatus using a user terminal according to the exemplary embodiment may include an access control unit configured to open the access door on the basis of the matching result.

The above-described solving means are merely illustrative but should not be construed as limiting the present disclosure. In addition to the above-described embodiments, additional embodiments may be further provided in the drawings and the detailed description of the present disclosure.

According to the present disclosure, it is possible to provide an apparatus and a method for face recognition using a user terminal which perform authentication for a face image of the user who wants to access a target space by utilizing encrypted face information stored in a user terminal.

According to the present disclosure, the security for encrypted face information is enhanced by utilizing a blockchain technique to maintain the security of the entire system even though an attack such as hacking is applied to a part of a control system.

However, the effect which can be achieved by the present disclosure is not limited to the above-described effects, there may be other effects.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram of an access control system including a face recognition apparatus using a user terminal according to an exemplary embodiment of the present disclosure;

FIG. 2 is a view illustrating an access control system according to an exemplary embodiment of the present disclosure which is provided in an access door;

FIG. 3 is a conceptual view for explaining a blockchain network which synchronizes and manages face information;

FIG. 4 is a view illustrating a format of face information which is managed by a blockchain network;

FIG. 5 is a schematic diagram of a face recognition apparatus using a user terminal according to an exemplary embodiment of the present disclosure; and

FIG. 6 is a flowchart for a face recognition method performed by a face recognition apparatus using a user terminal according to an exemplary embodiment of the present disclosure.

### DETAILED DESCRIPTION OF THE EMBODIMENT

Hereinafter, the present disclosure will be described more fully hereinafter with reference to the accompanying drawings, in which exemplary embodiments of the present disclosure are shown. However, the present disclosure can be realized in various different forms, and is not limited to the embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” or “indirectly coupled” to the other element through a third element.

Through the specification of the present disclosure, when one member is located “on”, “above”, “on an upper portion”, “below”, “under”, and “on a lower portion” of the other member, the member may be adjacent to the other member or a third member may be disposed between the above two members.

In the specification of the present disclosure, unless explicitly described to the contrary, the word “comprise” and variations such as “comprises” or “comprising”, will be understood to imply the inclusion of stated elements but not the exclusion of any other elements.

The present disclosure relates to an apparatus and a method for face recognition using a user terminal.

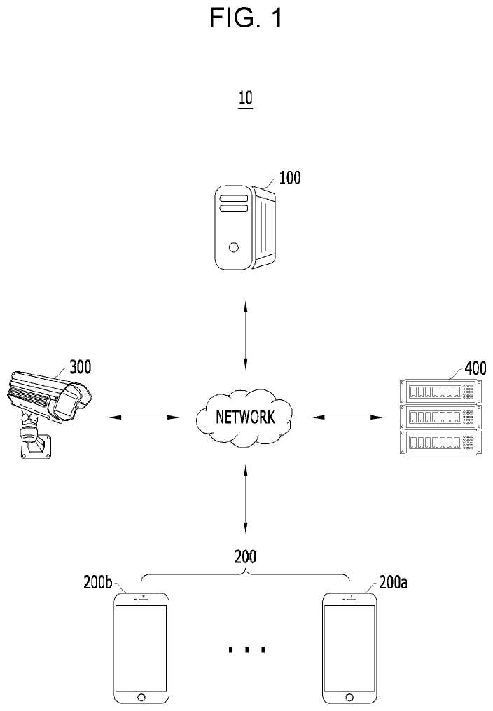

FIG. 1 is a schematic diagram of an access control system including a face recognition apparatus using a user terminal according to an exemplary embodiment of the present disclosure.

Referring to FIG. 1, an access control system 10 may include a face recognition apparatus 100 using a user terminal (hereinafter, simply referred to as “face recognition apparatus 100), a user terminal 200, a control camera 300, and a control station server 400.

The face recognition apparatus 100, the user terminal 200, the control camera 300, and the control station server 400 may communicate with each other via a network 20. The network 20 means a connection structure which allows information exchange between nodes such as terminals or servers. Examples of the network 20 include 3rd generation partnership project (3GPP) network, a long term evolution network, a 5G network, a world interoperability for microwave access (WiMAX) network, Internet, a local area network (LAN), a wireless local area network (wireless LAN), a wide area network (WAN), a personal area network (PAN), a Wi-Fi network, a Bluetooth network, a satellite broadcasting network, an analog broadcasting network, and a digital multimedia broadcasting (DMB) network, but are not limited thereto.

For example, the user terminal 200 may include all kinds of wireless communication devices such as a smart phone, a smart pad, a tablet PC, a personal communication system (PCS), a global system for mobile communication (GSM), a personal digital cellular (PDC), a personal handphone system (PHS), a personal digital assistant (PDA), an international mobile telecommunication (IMT)-2000, code division multiple access (CDMA)-2000, W-code division multiple access (W-CDMA), and a wireless broadband internet (Wibro) terminal.

In the description of the exemplary embodiment of the present disclosure, a “target space” is a terminology referring to an area in which after verifying that a subject 1 is an authenticated user through face recognition-based authentication process, the subject 1 enters. For example, the target space may be understood as the inside of a common entrance of a building (apartment, etc.), an individual household space of a building, or an interior space of a vehicle according to the implementation example of the present disclosure. Further, correspondingly to this, the access door 2 may be provided as various structures which spatially divide a space in which a subject who accesses the target space waits for authentication and the target space thereinside, such as an access gate, a swing gate, a sliding door, or a vehicle door.

Further, according to the exemplary embodiment of the present disclosure, the face recognition apparatus 100 may be loaded in an access door 2 as a sub module which performs a function for controlling the access door 2 to be open or closed. As another example, the face recognition apparatus 100 may be a sub module loaded in the control camera 300 to take image data of the subject 1. As another example, the face recognition apparatus 100 may be a main agent (for example, a server) which is provided independently from the access door 2 and/or the control camera 300 to analyze image data acquired by the control camera 300 and/or remotely control the access door 2 to be open and closed.

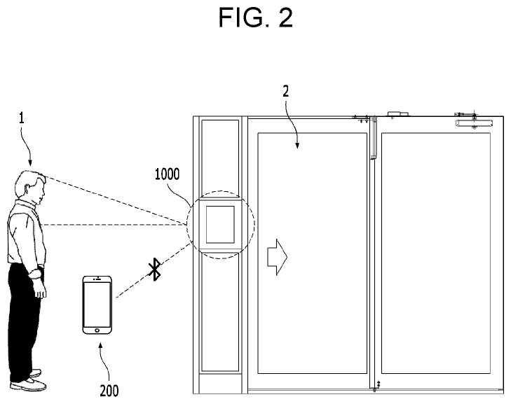

FIG. 2 is a view illustrating an access control system according to an exemplary embodiment of the present disclosure which is provided in an access door.

Referring to FIG. 2, the face recognition apparatus 100 may operate to interwork with the access door 2 which is provided in a boundary region of the target space to selectively allow a subject 1 who is a user who wants to access the target space to access and the control camera 300 installed to be adjacent to the access door 2. For better understanding, FIG. 2 illustrates an implementation example of the present disclosure in which the control camera 300 and the face recognition apparatus 100 are provided in a gate access control device 1000 installed in the common entrances of public buildings such as apartments.

First of all, the face recognition apparatus 100 may acquire image data including a facial region of the subject. For example, the face recognition apparatus 100 may receive (acquire) image data acquired by the control camera 300 installed to be adjacent to the access door 2 provided in the boundary region of the target space to selectively allow the subject 1 to access the target space from the control camera 300.

Further, the face recognition apparatus 100 may partition the facial region included in the image data. For example, the face recognition apparatus 100 may specify a facial region which is determined as a region corresponding to the face of the subject 1 among the image data, on the basis of position information of feature points corresponding to each body part of the subject extracted from the image data, angle information between reference lines obtained by connecting one pair of feature points, pixel color information, and feature information derived from a local region which forms an image and partition the boundary of the facial region in the form of a bounding box.

Further, the face recognition apparatus 100 may verify whether an image of the facial region corresponds to an actual face which is not forged or modified by analyzing the image data. For example, the face recognition apparatus 100 may determine whether the corresponding facial region shows a characteristic of the forged or modified face image obtained by printing a whole face of another person, printing only a part of a face portion to be replaced, or capturing the face with a mask worn on it, on the basis of the feature information of the facial region reflected in the image data.

With regard to this, when it is determined that the image data includes a forged or modified face image, the face recognition apparatus 100 considers that the image data is not effective so that the matching of the facial information is not performed and the access of the subject 1 is not allowed.

Further, when it is determined that the image data includes a forged or modified face image, the image recognition apparatus 100 may transmit a notification signal informing that there is an abnormal access attempt to the control station server 400.

Further, the face recognition apparatus 100 may acquire face information which is encrypted to be stored in the user terminal 200 of the subject 1.

For example, as illustrated in FIG. 2, when the subject 1 who wants to access the target space carries the user terminal 200 (in other words, when it is determined that a distance between the face recognition apparatus 100 and the user terminal 200 is within a predetermined distance), the face recognition apparatus 100 may receive (acquire) the encrypted face information from the user terminal 200 via the near field wireless communication.

With regard to this, the face recognition apparatus 100 may be interlinked (or paired) with the user terminal 200 to perform the near field wireless communication with the user terminal 200. For example, the face recognition apparatus 100 transmits a request for connecting near field wireless communication to the user terminal 200, and receives a permission input for the connection request from the user terminal 200 so that the face recognition apparatus 100 and the user terminal 200 may be put in a near field wireless communicable state.

As another example, while the subject 1 maintains a state in which the user terminal 200 carried by the subject 1 is close to a predetermined tagging position of the face recognition apparatus 100 or the gate access control device 1000 within a predetermined tagging distance, the encrypted face information may be transmitted from the user terminal 200 to the face recognition apparatus 100.

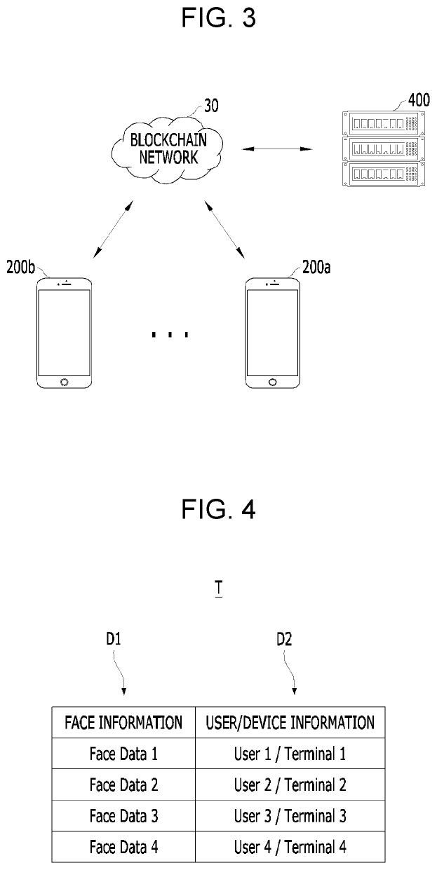

FIG. 3 is a conceptual view for explaining a blockchain network which synchronizes and manages face information.

Referring to FIG. 3, the user terminal 200 may participate in a blockchain network 30 to synchronize and manage the face information of the subject 1. According to the exemplary embodiment of the present disclosure, the blockchain network 30 may be a private blockchain network.

With regard to this, the private blockchain is a network which is relatively closed more than a public blockchain in which anyone can participate and only permitted nodes can participate therein. For example, with regard to a predetermined human group (for example, members of the same household, family members, and workers at the same workplace) to which the subject 1 belongs, the face information of each participating main agent may be stored (recorded) to be encrypted on a private blockchain network with a user terminal 200a carried by the subject 1, a surrounding terminal 200b carried by a surrounding person which is a user belonging to the group together with the subject 1, and the control station server 400 for managing accessors to the target space and managing access records as nodes, respectively.

According to the exemplary embodiment of the present disclosure, the encrypted face information which is stored through the blockchain network 30 may be information which includes facial regions of the users and is obtained by converting a face image which is captured in advance to satisfy a predetermined capturing condition into an encrypted format.

For example, the capturing condition may be a condition which is set in advance with regard to a resolution condition, a brightness condition, a size of the facial region, a cloth, a condition set to include a specific part (for example, ears, mouth, and eyes) so as to allow the face recognition apparatus 100 to easily match image data which is obtained by capturing a subject who is going to enter the target space in real time and an original image acquired by decoding the encrypted face information.

With regard to this, the control station server 400 receives a face image to be registered as encrypted face information from the user terminal 200 and encrypts the face image after determining whether the received face image satisfies the predetermined capturing condition to register and manage the face image in the blockchain network 30. As another example, the process which encrypts the face image after determining whether the face image satisfies the predetermined capturing condition to register the face image in the blockchain network 30 may be autonomously completed by the user terminal 200.

In the meantime, as another example, the encrypted face information which is stored and managed through the blockchain network 30 may be obtained by converting data associated with face feature information derived from a reference image which is captured in advance so as to include the facial region (for example, at least one image of the subject 1 stored in the storage of the user terminal 200).

For example, in the blockchain network 30, data obtained by converting face feature information including shape information of each part of the face and facial contour information identified from the reference image into a predetermined data type (for example, code information or tag information formed of letters/numbers) may be stored as encrypted face information.

FIG. 4 is a view illustrating a format of face information which is managed by a block chain network.

Referring to FIG. 4, the face information of each user may be registered (stored or recorded) on the blockchain network 30 in the form of a table T in which encrypted face information D1 and user/device information D2 including user's personal information, and identification information for a user terminal 200 possessed by each user are associated with each other to be stored.

In the meantime, according to the exemplary embodiment of the present disclosure, the encrypted face information D1 may be converted into a digital key format by a SHA256d cryptosystem algorithm or an elliptic curve cryptosystem (ECC) algorithm which is applied to the original face information (for example, a face image). However, it is not limited thereto and in the present disclosure, various cryptosystem algorithm models which have been known in the related art or will be developed in the future may be applied.

In summary, in the blockchain network 30 which encrypts and manages the face information of each user, the user terminal 200a of the subject 1, a surrounding terminal 200b which is a user terminal of the surrounding person having a predetermined personal relationship with the subject, and the control station server 400 provided to manage the accessor to the target space may participate.

In the meantime, according to the exemplary embodiment of the present disclosure, the face recognition apparatus 100 may receive encrypted face information of the subject 1 from the control station server 400 which participates in the blockchain network. For example, when the subject 1 does not carry the user terminal 200 (for example, a distance between the face recognition apparatus 100 and the user terminal 200 exceeds a predetermined distance) or face information is not provided on the basis of the near field wireless communication with the user terminal 200, the encrypted face information may be acquired from the control station server 400 which is a node belonging to the blockchain network 30 in which the user terminal 200 participates.

With regard to this, according to the exemplary embodiment of the present disclosure, when the distance between the face recognition apparatus 100 and the user terminal 200 is out of an available range of the near field wireless communication, the face recognition apparatus 100 may receive the encrypted face information from the control station server 400.

Further, according to the exemplary embodiment of the present disclosure, the face recognition apparatus 100 may determine a main agent who acquires the encrypted face information of the user to vary depending on the characteristic of the target space to be accessible by opening or closing the access door 2.

For example, a face recognition apparatus 100 provided in a public entrance that can be passed by a plurality of accessors in a public building formed of a plurality of households may be implemented to receive the encrypted face information from the control station server 400. A face recognition apparatus 100 provided in an individual household entrance may be implemented to receive encrypted face information from the user terminal 200 carried by the subject 1.

However, it is not limited thereto and according to the implementation example of the present disclosure, even a face recognition apparatus 100 provided in the individual household entrance may also be implemented to transmit encrypted face information of the subject 1 from the control station server 400 upon the request of the subject 1 or depending on whether the subject 1 carries the user terminal 200.

As described above, once the encrypted face information of the subject 1 is ensured, the face recognition apparatus 100 may determine whether the image data acquired by the real-time capturing matches the subject 1 on the basis of the image of the facial region of the subject 1 reflected to the acquired image data and the acquired encrypted face information.

With regard to this, according to the exemplary embodiment of the present disclosure, the face recognition apparatus 100 may determine whether to match, on the basis of whether a similarity of a facial feature reflected to the image data which is captured in real time and a reference characteristic acquired by decoding the encrypted face information satisfies a predetermined allowable level.

Further, when it is determined that the subject 1 is an authenticated user (in other words, the face information managed through the blockchain network 30 is a previously registered user) on the basis of the matching result of the image of the facial region of the subject 1 reflected to the image data and the acquired encrypted face information, the face recognition apparatus 100 may open the access door 2. For example, the face recognition apparatus 100 may transmit a control signal to request to open the access door 2 to a driving module (not illustrated) of the access door 2.

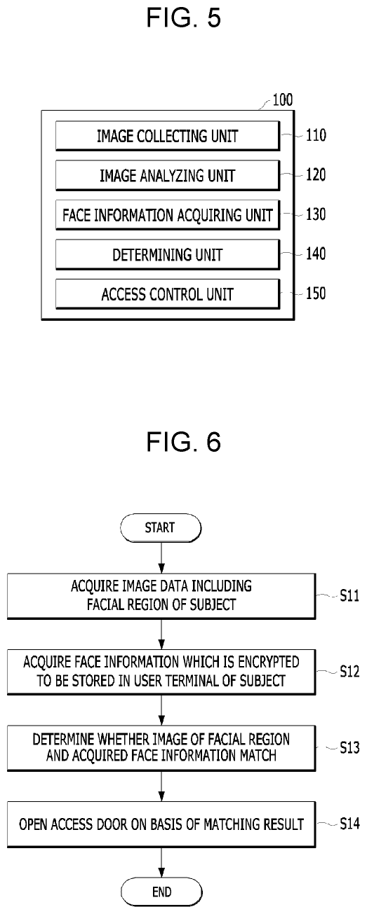

FIG. 5 is a schematic diagram of a face recognition apparatus using a user terminal according to an exemplary embodiment of the present disclosure.

Referring to FIG. 5, the face recognition apparatus 100 may include an image collecting unit 110, an image analyzing unit 120, a face information acquiring unit 130, a determining unit 140, and an access control unit 150.

The image collecting unit 110 may acquire image data including a facial region of the subject 1. Here, the image data may be acquired by the control camera 300 which is installed to be adjacent to the access door 2 provided in the boundary region of the target space so as to selectively allow the subject 1 to access the target space.

The image analyzing unit 120 may partition the facial region of the subject 1 included in the image data. Further, the image analyzing unit 120 may verify whether an image of the partitioned facial region corresponds to an actual face which is not forged or modified.

The face information acquiring unit 130 may acquire face information which is encrypted to be stored in a user terminal 200 of the subject.

Specifically, according to an exemplary embodiment of the present disclosure, the face information acquiring unit 130 may operate to be interlinked (paired) with the user terminal 200 to perform the near field wireless communication with the user terminal 200 and then receive the encrypted face information from the user terminal 200 through the near field wireless communication.

As another example, the face information acquiring unit 130 may receive the encrypted face information of the subject 1 from at least one of the surrounding terminal 200b and the control station server 400 which are main agents participating in the blockchain network 30 for synchronizing and managing the face information in which the user terminal 200 participates.

The determining unit 140 may determine whether the image data matches the subject on the basis of an image of the facial region of the subject 1 and face information encrypted to be stored in the user terminal 200.

The access control unit 150 may determine whether to open the access door 2 on the basis of the matching result derived by the determining unit 140.

Hereinafter, an operation flow of the present disclosure will be described in brief based on the above-detailed description.

FIG. 6 is a flowchart for a face recognition method performed by a face recognition apparatus using a user terminal according to an exemplary embodiment of the present disclosure.

A face recognition method performed by a face recognition apparatus using a user terminal illustrated in FIG. 6 may be performed by the above-described face recognition apparatus 100. Accordingly, even though some contents are omitted below, if the contents have been described for the face recognition apparatus 100, the contents may also be applied to the description for the face recognition method performed by the face recognition apparatus using a user terminal in the same way.

Referring to FIG. 6, in step S11, the image collecting unit 110 may acquire image data including a facial region of the subject 1.

Specifically, according to the exemplary embodiment of the present disclosure, in step S11, the face collecting unit 110 may receive image data acquired by the control camera 300 installed to be adjacent to the access door 2 provided in the boundary region of the target space to selectively allow the subject 1 to access the target space from the control camera 300.

Next, in step S12, the face information acquiring unit 130 may acquire face information which is encrypted to be stored in the user terminal 200 of the subject 1.

Next, in step S13, the determining unit 140 may determine whether an image of the facial region and the face information match on the basis of the image of the facial region of the image data acquired in step S11 and the encrypted face information acquired in step S12.

Next, in step S14, the access control unit 150 may open the access door 2 on the basis of the matching result in step S13.

In the above description, steps S11 to S14 may be further divided into additional steps or combined as smaller steps depending on an implementation example of the present disclosure. Further, some steps may be omitted if necessary and the order of steps may be changed.

The face recognition method performed by the face recognition apparatus using a user terminal according to the exemplary embodiment of the present disclosure is implemented in the form of a program instruction which can be executed by various computer means to be recorded in a computer readable medium. The computer readable medium may include solely a program instruction, a data file, and a data structure or a combination thereof. The program instruction recorded in the medium may be specifically designed or constructed for the present disclosure or known to those skilled in the art of a computer software to be used. An example of the computer readable recording medium includes magnetic media, such as a hard disk, a floppy disk, and a magnetic tape, optical media, such as a CD-ROM and a DVD, magneto-optical media, such as a floptical disk, and a hardware device, such as a ROM, a RAM, a flash memory, specially formed to store and execute a program instruction. Examples of the program instruction include not only a machine language code which is created by a compiler but also a high level language code which may be executed by a computer using an interpreter. The hardware device may operate as one or more software modules in order to perform the operation of the present disclosure and vice versa.

Further, the above-described face recognition method performed by the face recognition apparatus using a user terminal may also be implemented as a computer program or an application which is stored in a recording medium and is executed by a computer.

The above description of the present disclosure is illustrative only and it is understood by those skilled in the art that the present disclosure may be easily modified to another specific type without changing the technical spirit of an essential feature of the present disclosure. Thus, it is to be appreciated that the embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. A face recognition method performed by a face recognition apparatus using a user terminal, comprising:
acquiring image data including a facial region of a subject;
acquiring face information which is encrypted to be stored in a user terminal of the subject; and
determining whether an image of the facial region and the face information match each other.

2. The face recognition method according to claim 1, wherein the image data is acquired by a control camera which is installed to be adjacent to an access door provided in a boundary region of a target space so as to selectively allow the subject to access the target space.

3. The face recognition method according to claim 2, wherein the acquiring of face information includes:
allowing the face recognition apparatus to be interlinked with the user terminal to perform near field wireless communication with the user terminal; and
allowing the face recognition apparatus to receive the face information from the user terminal through the near field wireless communication.

4. The face recognition method according to claim 2, wherein the user terminal participates in a blockchain network for synchronizing and managing the face information.

5. The face recognition method according to claim 4, wherein the face information is encrypted with a predetermined digital key format associated with the blockchain network.

6. The face recognition method according to claim 4, wherein in the blockchain network, a surrounding terminal which is a user terminal of a surrounding person having a predetermined personal relationship with the subject and a control station server provided to manage an accessor to the target space participate, and
in the acquiring of face information, the face information is received from the control station server.

7. The face recognition method according to claim 6, wherein in the acquiring of face information, when a distance between the face recognition apparatus and the user terminal is out of an allowable range of the near field wireless communication, the face information is received from the control station server.

8. The face recognition method according to claim 2, further comprising:
opening the access door on the basis of the matching result.

9. The face recognition method according to claim 1, further comprising:
after the acquiring of image data,
partitioning the facial region included in the image data; and
verifying whether the image of the facial region corresponds to an actual face which is not forged or modified.

10. A face recognition apparatus using a user terminal, comprising:
an image collecting unit configured to acquire image data including a facial region of a subject;
a face information acquiring unit configured to acquire face information which is encrypted to be stored in a user terminal of the subject; and
a determining unit configured to determine whether an image of the facial region and the face information match each other.

11. The face recognition apparatus according to claim 10, wherein the image collecting unit receives the image data from a control camera which is installed to be adjacent to an access door provided in a boundary region of a target space so as to selectively allow the subject to access the target space.

12. The face recognition apparatus according to claim 11, wherein the face information acquiring unit is interlinked with the user terminal so as to allow the near field wireless communication with the user terminal and receives the face information from the user terminal through the near field wireless communication.

13. The face recognition apparatus according to claim 11, wherein the user terminal and a control server provided to perform accessor management to the target space participate in a blockchain network to synchronize and manage the face information and
the face information is encrypted with a predetermined digital key format associated with the blockchain network.

14. The face recognition apparatus according to claim 13, wherein the face information acquiring unit receives the face information from the control station server.

15. The face recognition apparatus according to claim 11, further comprising:
an access control unit configured to open the access door on the basis of the matching result.
